(19) United States
(12) Patent Application Publication
(10) Pub. No.: US 2007/0218217 A1
(43) Pub. Date: Sep. 20, 2007

(54) ADJUSTABLY OPAQUE FILM FOR SUBSTANTIALLY SMOOTH SURFACE

(76) Inventors: Primal Fernando, Boulder, CO (US); Noel Clark, Boulder, CO (US)

Correspondence Address: PARK LAW FIRM, 3255 WILSHIRE BLVD, SUITE 1110, LOS ANGELES, CA, 90010, US

(21) Appl. No.: 11/308,347

(22) Filed: Mar. 17, 2006

(51) Int. Cl. C09K 19/00

(52) U.S. Cl. 428/1.31; 428/1.1

(57) ABSTRACT

An adjustably opaque film, including substantially flexible/transparent confining films and light transmission control layers, is provided. The inner surfaces of the first and second confining films form a confined space layer with substantially constant thickness. The adjustably opaque film is applied on a window panel which is already installed like a regular window pane on a building or an automobile. The film is not sandwiched between two window panels or panes. The film is adapted to be applied on a surface of window panels. The film is substantially flexible enough to be able to be easily handled and applied on the window panel in conventional construction site conditions. The interval between the first and second confining films is from about one (1) millimeter to about two (2) millimeters, which is an important point along with the flexibility.

### BACKGROUND OF THE INVENTION

The present invention relates to a window having adjustable opacity. More particularly, this invention relates to an adjustable or variable window tinting system for the vehicle and architectural industries, and further, a window system for sunlight protection.

Vehicle and building windows that transmit a fixed fraction of incident light are desired by many, and are currently commercially available to control the sunlight intrusion into vehicles and buildings. Such windows with a fixed tint, while desired by users during bright sunlight days, are undesirable on cloudy days and in the evenings. Windows are needed where a controllable fraction of incident visible light intensity can be applicable under varying environmental as well as social conditions and needs. A protective variable tinting that controls the visible light transmitting through the window, in fractions, and at the same time filter out UV and infrared light is highly desirable.

Considering the vast number of regular windows installed already, it will be desirable to provide a film that can be applied to the regular windows and coverting it into an energy-efficient and transmission-controllable window.

### SUMMARY OF THE INVENTION

The present invention contrives to meet the need for an improved light-controlling film.

An objective of the invention is to provide an adjustably opaque film that is flexible and can be applied on the surface of regular windows.

Another objective of the invention is to provide a film that automatically or manually, variably changes its opacity depending on ambient lighting situations.

Another objective of the invention is to provide an adjustably opaque film that is durable and thin enough for a vehicle window.

Still another objective of the invention is to filter the UV and infrared light out of vehicles or buildings.

Still another objective of the invention is to provide an adjustably opaque film that can gradually change its color or tint.

Still another objective of the invention is to provide a robust and dimensionally flexible enclosure for electro-optic materials such as liquid crystal for window applications.

To achieve the above objectives, an adjustably opaque film, including first and second substantially flexible/transparent confining films, and one or more light transmission control layers, is provided.

The first substantially flexible and transparent confining film has an inner surface and an outer surface.

And, the second substantially flexible and transparent confining film has an inner surface and an outer surface. The inner surfaces of the first and second confining films form a confined space layer with substantially constant thickness.

The adjustably opaque film can be applied on a window panel that is already installed like a regular window pane on a building or an automobile. The adjustably opaque film does not need to be sandwiched between two window panels or panes. The film is totally independent and self-supporting.

To achieve that, one of the first and second confining films is adapted to be attached to the window panel or pane. The adjustably opaque film is adapted to be applied on a surface of window panels including automobile and building windows.

The adjustably opaque film is substantially flexible enough to be able to be easily handled and applied on the window panel in conventional construction site conditions.

The interval between the first and second confining films is preferably from about one (1) millimeter to about two (2) millimeters, which is an important point along with the flexibility. However, the interval between the first and second confining films should not be limited to the above identified interval.

The adjustably opaque film may further include two or more polarizing layers and a plurality of shock absorbing layers.

At least one of the polarizing layers is disposed on each side of the light transmission control layer.

The shock absorbing layer is interposed between any two of the confining films, light transmission control layers, and polarizing layers.

The shock absorbing layers are adapted to support the layers mechanically and to hold the layers together, and the adjustably opaque film controls the light transmission by controlling the active optical property of the light transmission control layer.

The attachment among the first and second confining films, and the light transmission control layer, and the shock absorbing layer is done with techniques often employed by glass lamination processes, such as those using polyvinyl butyral (PVB), or optically clear UV curable resins such as those under the trade name of Astrocure 1000G, and may further include the use of pressure sensitive adhesive.

The shock absorbing layer includes lamination materials such as polyvinyl butyral (PVB), UV curable clear resins such as Astrocure 1000G, and or pressure sensitive adhesives that are further designed to have or to enhance their shock absorbing properties while providing the function of attachment among various layers.

Alternatively, the shock absorbing layer includes gel that fills the cavity, and the light transmission control layer is supported in the gel.

Alternatively, the shock absorbing layer includes a first flexible sheet, and the light transmission control layer is attached to the first flexible sheet. The shock absorbing layer may further include a second flexible sheet, and the second flexible sheet is attached to the light transmission control layer opposite to the first flexible sheet.

Preferably, the first and second flexible sheets are made of polyester or polycarbonate, and their thickness should be in a range from about 0.1 to about 0.2 mm.

In a preferred embodiment, the light transmission control layer includes a plurality of light transmission control cells that are arranged to form a seamlessly tiled lattice structure.

The opacity of the light transmission control cells, or the light transmission control layer within, is variably adjustable. The opacity of each of these cells, or of the layer, is adjusted by applying an external stimulus such as an external electric field and by changing the amplitude of such an electric field.

Each of the light transmission control cells includes a first electrode, a second electrode, and an electro-optic material in between the first and second electrodes. The electro-optic material may be, and not limited to liquid crystals, nonlinear optical material, and other optical materials having similar characteristics.

The types of liquid crystal which forms the light transmission layer may include but not limited to nematic liquid crystals with or without chiral dopants, chiral nematic liquid crystals, polymeric liquid crystals, ferroelectric liquid crystals. Such liquid crystal may be doped with dichroic light absorbing dye, or with light absorbing dye.

The adjustably opaque window further includes a first polarizing layer that is positioned between the first confining film and the light transmission control layer, and a second polarizing layer that is positioned between the first flexible sheet and the second confining film. The direction of polarization of the first polarizing layer is substantially perpendicular to the direction of polarization of the second polarizing layer.

The first and second polarizing layers may be integrated with the first and second confining films, respectively. The first polarizing layer is absorptive, or birefringence based. Also, the first polarizing layer may include wire grids of metals.

In the light transmission cell, the first electrode is substantially adjacent the first polarizing layer, and the second electrode is substantially adjacent the second polarizing layer.

The first electrode includes a substantially transparent plastic substrate coated with transparent conductive coating, and the second electrode includes a substantially transparent plastic substrate coated with transparent conductive coating.

The first electrode, which is adjacent the liquid crystals, is treated with a first polymer layer such that the first polymer layer gives a preferential alignment to the adjacent liquid crystal. The surface of the second electrode, which is adjacent to the liquid crystal, is treated with a second polymer layer such that the second polymer layer gives a preferential alignment to the adjacent liquid crystal.

The liquid crystals adjacent the first and second polymer layers are pre-tilted from the planes of the first and second polymer layers. The preferential direction of the treated first polymer layer is substantially parallel to the direction of polarization of the first polarizing layer, and the preferential direction of the treated second polymer layer is substantially parallel to the direction of the second polarization layer.

Preferably, the pre-tilting angle is in a range from 0° to about forty five degrees (45°). More preferably, the pre-tilting angle is about thirty degrees (30°).

The light control transmission cell further includes a plurality of spacers, and the spacers maintain predetermined distance between the first and second electrodes. Part or all of the spacers are coated with adhesive. The spacers are randomly distributed within the light transmission control cell. Each of the spacers includes a sphere, and the sphere contacts the first and second electrodes. The sphere is coated with an adhesive layer. The diameter of the sphere is in a range from about five (5) to about thirty (30) microns, and the thickness of the adhesive layer is less than about five (5) microns.

The first flexible sheet and the second flexible sheet are coated with a transparent, electrically conductive coating, such as Indium Tin Oxide. The transparent conductive coating of the flexible sheets forms the electrical wiring to each of the light transmission control cells.

The adjustably opaque window further includes a control circuit that controls each of the light transmission control cells individually or collectively, in part or in whole, with the electrical wiring.

The adjustably opaque film further includes a light sensor that measures the intensity of the incident light, and the control circuit controls the light transmission of the light transmission control cells based on data provided by the light sensor. The light transmission of the light transmission control cells may be controlled manually.

The adjustably opaque film further includes an array of photovoltaic cells, and the array provides electricity for operation of the light transmission control layer. The adjustably opaque film may be a vehicle window, and the array may be installed in a vehicle. Other applications of the adjustably opaque film include an architectural window, a glass door, or a partition.

The adjustably opaque film further includes an ultra violet light blocking layer that is positioned between the first confining film and the light transmission control layer.

The present invention is summarized in a different aspect below.

A controllable protective tinting film allows the transmission of visible light to be adjusted by external means, while the UV and infrared light are absorbed or reflected out of the building or vehicle. An important mode of control in tinting applications is the electrical manipulation of optical properties of an active layer.

This is the central layer of the light control layer shown in FIG. 1, with which transmittance of light through the active layer is controlled. An expanded view of the light control layer is shown in FIG. 2. Films of electrically active material such as liquid crystals, often in combination with auxiliary layers, can change the transmittance of light in a way that depends on the external electrical stimulus applied.

Auxiliary layers can be composed of layers of polarizers of various types, layers necessary for application of external stimulus such as an electric field, and layers necessary for proper operation of active layers, such as alignment layers and compensation layers to enhance the light attenuation effects for obliquely incident light, when the active layer is liquid crystal.

The unwanted visible light can be reflected, diffracted to the exterior of the vehicle, or absorbed, and/or a combination of all these modes, by the active layer and its auxiliary elements.

The control of visible light transmittance through the light control layer derives from the ability that the optical properties of the active layer can be manipulated using an external stimulus such as an electrical field. Active layers, such as liquid crystals, can change their optical properties such as their birefringence and hence the polarization state of the light traveling through the active layer, when an external stimulus such as an electrical field is applied.

More explicitly, the application of an external stimulus such as an external electrical field to the liquid crystal layer causes liquid crystal molecules, such as those liquid crystals composed of rod-shaped molecules, to reorient. This molecular reorientation in the liquid crystal layer causes a change in the index of refraction of the light traveling through the glass. As a result, there is a change in the polarization of light exiting the liquid crystal layer, due to the application of the external stimulus to the liquid crystal active layer.

Still more explicitly and more generally, the degree of liquid crystal molecular reorientation is dependent on the amplitude of the external stimulus, and the state of light traveling through the liquid crystal layer can be manipulated continuously by manipulating the external stimulus.

The active liquid crystal layer or auxiliary layers such as polarizers can then be used to absorb or reflect a fraction of visible light depending on the choice of polarizers and depending on the polarization state of the light, which is controlled by the active layer. Active layers, such as dichroic dye doped liquid crystals can change their absorbance of light upon the application of an external stimulus such as an electrical field, and therefore control the transmittance of light through the active layer using an external stimulus.

The filtering of UV and or infrared light can be achieved by auxiliary layers, such as an additional UV absorption layer, polarizers, and or other active layers, depending on the choice of such materials. External stimulus applied to the active layer to achieve transmittance change in the visible spectrum will have little or no effects on the filtering of UV and infrared by the light control layer.

A variety of window sizes are employed in commercial applications and specifically in building, vehicle, land, marine or air, applications. For large windows, according to the current invention, the active layer is structured such that several smaller active layers joined seamlessly together for a tiled structure and the collection of these smaller tiles, acts as one single active layer that controls the passage of light of the whole panel, as depicted in FIG. 3.

Protective adjustably opaque windows according to the present invention offer a number of advantages.

Natural sunlight radiation has a broad spectrum in the optical frequency regime, ranging from ultraviolet to infrared beams. Ultraviolet (UV) light can induce photochemical reactions, particularly in organic systems, and are harmful to occupants as well as the interior of a vehicle or building. The UV filtering feature provided by the protective adjustably opaque window is an added environmental safety feature which alleviates the problem of use of sunscreen products for the occupants and protects the interior from deteriorating due to UV radiation. UV radiation damage to active layers, such as active layers made using liquid crystals, can also be minimized or eliminated by preventing UV from entering the active layers.

The infrared spectrum of sunlight radiation can be absorbed by materials that make up the interior of a vehicle or building, and are a very significant portion of heat converted from absorption of light. According to the present invention, the light control layer can filter out the infrared. The filtering of this infrared spectrum can reduce the temperature rise of the interior of a vehicle or building due to this converted heat, and reduce the energy and cost of desired cooling of a vehicle or building on a hot day.

The primary function, and thus the advantage of the adjustably opaque window is that it reduces the transmission of unwanted light when the light setting is too bright, and it can be tuned for maximum transmission in a darker light setting. An additional advantage of the use of the protective adjustably opaque window is that they can provide privacy under a wide range of natural lighting conditions. Unless a near perfect reflection mirror is placed in the interior of the setting protected by the window, the reflected light is stronger than that passing through a window from behind in typical applications. Thus objects on the dimmer interior side of the window will be obscured to observers on the brighter side by the reflected exterior light. Privacy can be further enhanced by controlling the tint, to reduce the transmission of light through the window.

In another embodiment of the present invention, an adjustably opaque film includes:

(1) a light transmission control layer;

(2) first and second electrodes, enveloping the light transmission control layer, including a transparent electrically conductive coating, a transparent plastic substrate, and a brushed polymer layer;

(3) first and second inner shock absorbing layers enveloping light transmission control layer and the electrodes;

(4) first and second polarizing layers enveloping the light transmission control layer, the electrodes, and the inner shock absorbing layers;

(5) first and second outer shock absorbing layers, having inner and outer surfaces, enveloping the light transmission control layer, the electrodes, the inner shock absorbing layers, and the polarizing layers;

(6) a first substantially flexible and transparent confining film disposed on the outer surface of the first outer shock absorbing layer; and

(7) a second substantially flexible and transparent confining film disposed on the outer surface of the second outer shock absorbing layer.

The adjustably opaque film may further include an ultraviolet light blocking layer and a shock absorbing layer that are positioned between the second confining film and the light transmission control layer.

The preferred interval between the first and second confining films is from about one (1) millimeter to about two (2) millimeters; however, the interval may vary substantially to fit the design requirements.

Although the present invention is briefly summarized, the fuller understanding of the invention can be obtained by the following drawings, detailed description and appended claims.

### DESCRIPTION OF THE FIGURES

These and other features, aspects and advantages of the present invention will become better understood with reference to the accompanying drawings, wherein:

FIG. 1 is a schematic diagram of an adjustably opaque window with its principal functions depicted;

FIG. 2 is an expanded view of the light control layer;

FIG. 3 is a schematic diagram showing a tiling structure of the active layers;

FIG. 4 is an elevation view showing an adjustably opaque window according to the present invention;

FIG. 5 is a partial cross-sectional view of the window taken along the line 5-5 of FIG. 4;

FIG. 6 is a view similar to FIG. 5 showing a cavity between the first and second confining films;

FIG. 7 is a view similar to FIG. 5 showing a shock absorbing layer;

FIG. 8 is an elevation view of the window showing a lattice of light transmission control cells;

FIG. 9 is a cross-sectional view of the light transmission control cell within the window;

FIG. 10 is a plan view of spacers in the light transmission control cell;

FIG. 11 is a partial cross-sectional view taken along the line 11-11 of FIG. 10;

FIG. 12 is a cross-sectional view taken along the line 12-12 of FIG. 11;

FIG. 13 is a schematic circuit diagram that shows controlling of the light transmission control cells;

FIG. 14 is a view similar to FIG. 7 showing that the shock absorbing layer includes gel;

FIG. 15 is an elevation view of the window showing a different partition with the cells;

FIG. 16 is a partial cross-sectional view taken along the line 16-16 of FIG. 15;

FIG. 17 is an elevation view of the window showing a different partition with the cells;

FIG. 18 is an elevation view of the window showing a different partition with the cells; and

FIG. 19 is a cross-sectional view of the adjustably opaque window.

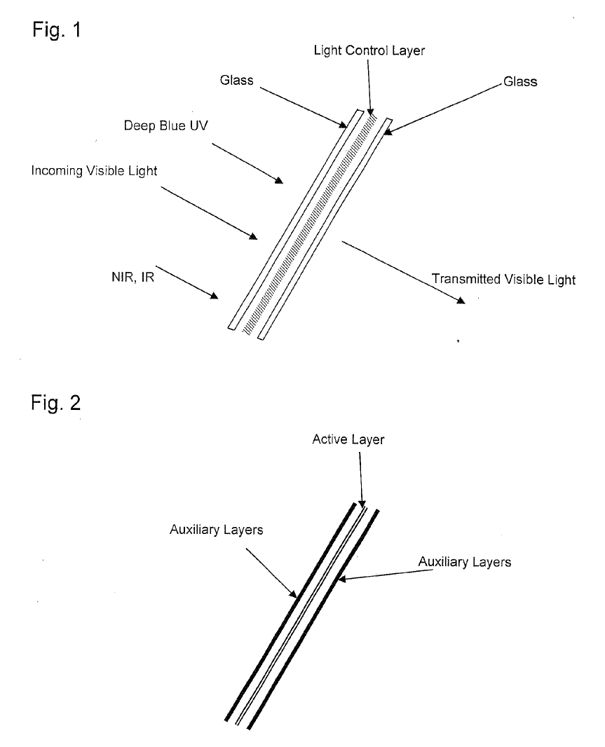

### DETAILED DESCRIPTION OF THE INVENTION

The control of visible light transmittance through the light transmission control layer derives from the ability that the optical properties of an active layer, which is the central layer of the light transmission control layer, can be manipulated using an external stimulus such as an electrical field. Active layers, such as liquid crystals, can change their optical properties such as their birefringence and hence the polarization state of the light traveling through the active layer, when an external stimulus such as an electrical field is applied.

More explicitly, the application of an external stimulus such as an external electrical field to the liquid crystal layer causes liquid crystal molecules, such as those liquid crystals composed of rod-shaped molecules, to reorient. This molecular reorientation in the liquid crystal layer causes a change in the index of refraction of the light traveling through the glass. As a result, there is a change in the polarization of light exiting the liquid crystal layer, due to the application of the external stimulus to the liquid crystal active layer.

Still more explicitly and more generally, the degree of liquid crystal molecular reorientation is dependent on the amplitude of the external stimulus, and the polarization state of light traveling through the liquid crystal layer can be manipulated continuously by manipulating the external stimulus.

Auxiliary layers such as polarizers can then be used to absorb or reflect a fraction of visible light depending on the choice of polarizers and depending on the polarization state of the light, which is controlled by the active layer. Active layers, such as dichroic dye doped liquid crystals can change their absorbance of light upon the application of an external stimulus such as an electrical field, and therefore control the transmittance of light through the active layer using an external stimulus.

The filtering of UV and or infrared light can be achieved by auxiliary layers, such as an additional UV absorption layer, polarizers, and or other active layers, depending on the choice of such materials. External stimulus applied to the active layer to achieve transmittance change in the visible spectrum will have little or no effects on the filtering of UV and infrared by the light control layer.

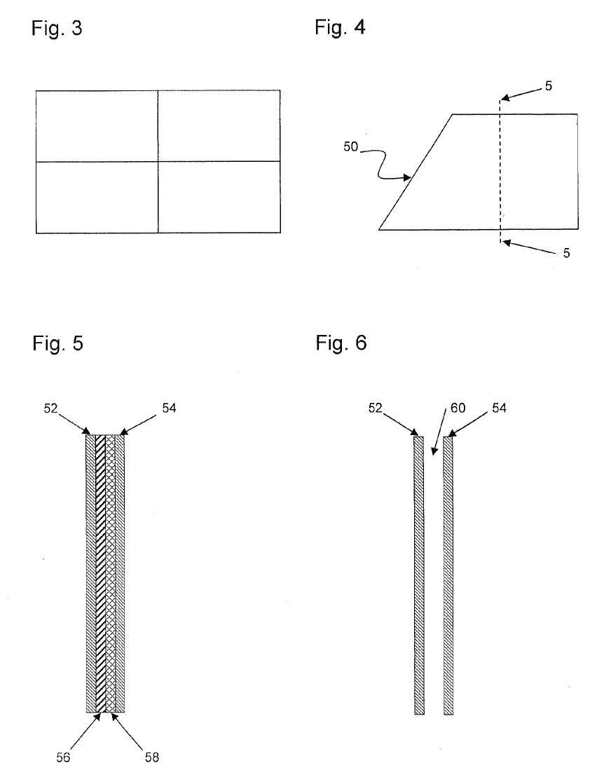

A variety of window sizes are employed in commercial applications and specifically in building, vehicle, land, marine or air, applications. For large windows, according to the current invention, the active layer may structured such that several smaller active layers joined seamlessly together for a tiled structure and the collection of these smaller tiles, acts as one single active layer that controls the passage of light of the whole panel, as depicted in FIG. 3.

The light control layer, including an active layer, can assume a variety of layered structures with varying layer thickness and layer structures. A variety of electro optic materials can be used as the active layers. Such layers can be made up of liquid crystals, polymer liquid crystals, or other optical materials such as nonlinear optical materials.

In one of the preferred embodiments, the active layer includes a liquid crystal layer, which is bounded by substrates such as a pair of non-intersecting glass or flexible polymer substrates like polyester or polycarbonate films. The substrates generally further includes transparent conductive layers, through which external stimulus such as electricity can be applied to liquid crystals, and other overcoats such as polymer or inorganic thin layers for various purposes including alignment of liquid crystals, prevention of electrically shorting the two substrates, and prevention of penetration of moisture to the active liquid crystal layers. The substrates may further be doped with metallic materials such as silver or conducting polymers such as polyaniline to increase the electrical conductivity of the substrates. The liquid crystal layer is bounded by a pair of polarizers, with their polarization selection direction nominally at 0 or 90 degrees to each other.

In this preferred embodiment of using liquid crystal as an active layer, the liquid crystals can be nematic, with or without chiral dopants, or the liquid crystal active layer can be a layer of chiral nematic liquid crystals. Further, the liquid crystal active layer can be other forms of liquid crystals such as polymeric liquid crystals or ferroelectric liquid crystals. Further, the liquid crystal layer may be doped with dichroic or pleochroic light absorbing dyes. Addition of such dyes can assist with needed transmission control for the variable tinting applications.

Still in this preferred embodiment, the polarizers can be reflective in nature, where the reflective polarizers can be birefringence based or wire grids of metals which further can reflect infrared light and at least partially block the UV light. Further, the polarizers can be absorptive in nature, where the selection of polarization is achieved by absorbing light in the unwanted polarization direction by the polarizing film.

In another preferred embodiment of using liquid crystal as the active layer, the liquid crystals can be nematic doped with dichroic or pleochroic light absorbing dyes, and the dielectric anisotropy is negative. In this preferred embodiment, no polarizers may be necessary to achieve tinting control.

In another preferred embodiment, the light control layer, in addition to the active layer such as liquid crystal layer discussed above, includes a UV layer and a IR filtering layer with proper filtering functions laminated to the window glass or the active layer assembly.

In one preferred embodiment, the protective variable tinting window can be fabricated by first making the light control layer and laminating it between two panes of window glass, using adhesive layers such as pressure sensitive adhesive. In yet another embodiment, the light control layer can be laminated onto the inner side of a window glass in a way similar to the lamination of a fixed sheet window tint material. The adhesive material can again be such material as pressure sensitive adhesive films.

Still in another preferred embodiment, smaller light control layer or active layers are arranged in two rolls or two columns so that the active layers can be tiled seamlessly in the interior of the window while the means of applying external stimulus can be conveniently hidden along the edges of the window.

Still in another preferred embodiment, the external stimulus can be an electric stimulus, which can be an oscillatory electrical field from the power supply in the building or the circuitry that is powered by the battery system of the vehicle. Alternatively, the circuitry may be powered by solar cells that are laminated on the top section of the glass in the window of the building or the windshield glass in an automobile.

The present invention is further explained with reference to FIGS. 4-18.

FIGS. 4 and 5 show an adjustably opaque film 50 according to the present invention.

To achieve the above objectives, an adjustably opaque film 50, including first and second substantially flexible/transparent confining films 52, 54, one or more light transmission control layer 56, is provided.

The first substantially flexible and transparent confining film 52 has an inner surface 151 and an outer surface 152 as shown in FIG. 6.

And, the second substantially flexible and transparent confining film 54 has an inner surface 153 and an outer surface 154. The inner surfaces 151, 152 of the first and second confining films 52, 54 form a confined space layer or cavity 60 with substantially constant thickness.

The adjustably opaque film 50 is applied on a window panel (not shown) which is already installed like a regular window pane on a building or an automobile. The adjustably opaque film 50 is not sandwiched between two window panels or panes. The film 50 is self-supporting.

For that, one of the first and second confining films 52, 54 is adapted to be attached to the window panel or pane. The adjustably opaque film 50 is adapted to be applied on a surface of window panels including car windows and building windows.

The adjustably opaque film 50 is substantially flexible enough to be able to be easily handled and applied on the window panel in the conventional construction site conditions.

The interval between the first and second confining films 52, 54 is from about one (1) millimeter to about two (2) millimeters, which is an important point along with the flexibility.

The adjustably opaque film 50 may further include two or more polarizing layers 76, 78 and a plurality of shock absorbing layers 58.

At least one of the polarizing layers 76, 78 is disposed each side of the light transmission control layer 56.

The shock absorbing layer 58 is interposed between any two of the confining films 52, 54, light transmission control layers 56, and polarizing layers 76, 78.

The shock absorbing layers 58 are adapted to support the other layers mechanically and to hold the layers together, and the adjustably opaque film 50 controls the light transmission by controlling the active optical property of the light transmission control layer 56.

The film 50 includes a first confining film 52, a second confining film 54, a light transmission control layer 56, and a shock absorbing layer 58. The light transmission control layer 56 is supported by the shock absorbing layer 58. For the effectiveness of illustration, the elements are not drawn to scale throughout the drawings. Attachment among the first confining film 52, the second confining film 54, the light transmission control layer 56, and the shock absorbing layer 58 is done with pressure sensitive adhesive.

FIG. 6 shows that the first confining film 52 and the second confining film 54 provide a cavity 60 between them. The light transmission control layer 56 and the shock absorbing layer 58 are positioned in the cavity 60 as shown in FIG. 5.

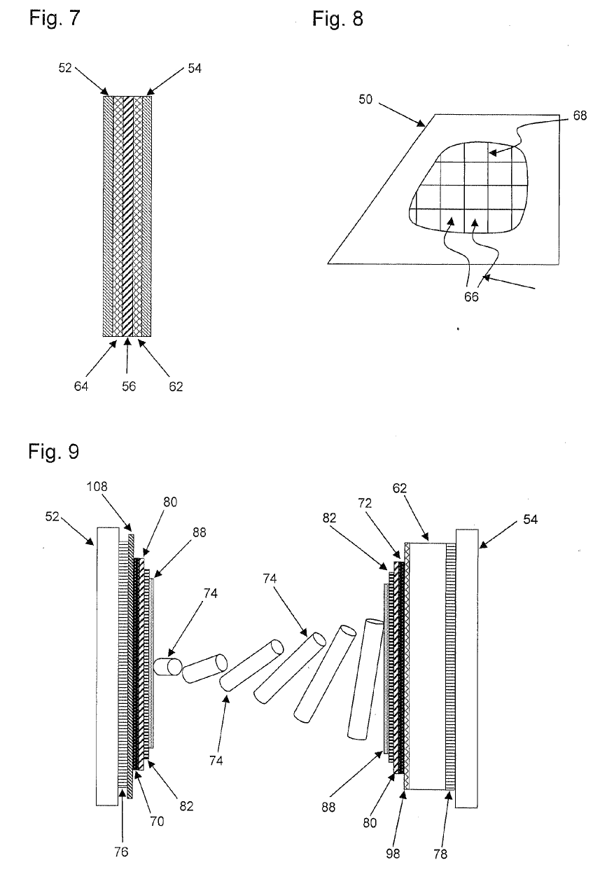

FIG. 7 shows that the shock absorbing layer 58 includes a first flexible sheet 62, and an optional second flexible sheet 64. The light transmission control layer 56 is attached to the first flexible sheet 62. The second flexible sheet 64 is attached to the light transmission control layer 56 opposite to the first flexible sheet 62. Moreover, a plurality of flexible sheets may be added on the either side of the light transmission control layer to strengthen and toughen the window. Preferably, the material for the flexible sheets 62, 64 is polyester or polycarbonate, and the thickness of the flexible sheets is in a range from about 0.1 to about 0.2 mm. The first flexible sheet 62 protects the light transmission control layer 56, which may include a fragile material including liquid crystal, from external shock.

Preferably, the first confining film 52 and the second confining film 54 are substantially hard to provide structural rigidity required for various applications. For example, the panes 52, 54 are made of glass or plastic. Other light transmitting panes are also acceptable.

FIG. 8 shows that the light transmission control layer 56 includes a plurality of light transmission control cells 66. The light transmission control cells 66 are arranged to form a lattice 68. Although a lesser number of the light transmission control cells 66 may be used when larger cells are used, it is preferable to use smaller light transmission control cells 66 to provide more redundancy and flexibility. The opacity of the light transmission control cell 66 is variably adjustable by changing amplitude of electric field applied on the light transmission control cell 66. Tiling the film 50 with the light transmission control cells 66 makes manufacturing of the film 50 substantially easier.

FIG. 9 shows that the light transmission control cell includes a first electrode 70, a second electrode 72, and an electro-optic material 73 in between the first and second electrodes 70, 72.

The electro-optic material 73 includes liquid crystal 74, or nonlinear optical material. The liquid crystal includes dichroic dye doped liquid crystals, nematic liquid crystals with or without chiral dopants, chiral nematic liquid crystals, polymeric liquid crystals, and ferroelectric liquid crystals. The liquid crystal may be doped with dichroic light absorbing dye, or pleochoric light absorbing dye.

More general description of liquid crystal used in light transmission control is given in U.S. Pat. No. 5,197,242, the disclosure of which is incorporated by reference into this application.

The film 50 further includes a first polarizing layer 76 that is positioned between the first confining film 52 and the light transmission control layer 56, and a second polarizing layer 78 that is positioned between the first flexible sheet 62 and the second confining film 54.

The direction of polarization of the first polarizing layer 76 is substantially perpendicular to the direction of polarization of the second polarizing layer 78.

The first polarizing layer 76 and the second polarizing layer 78 may be integrated with, within, as a part of, or alongside the first confining film 52 and second confining film 54, respectively.

The first polarizing layer 76, which receives the incident light from outside, may be absorptive, birefringence based, or include wire grids of metals for better filtering effect against unwanted lights.

In the light transmission control cell 66, the first electrode 70 is substantially adjacent the first polarizing layer 76, and the second electrode 72 is substantially adjacent the second polarizing layer 78. The liquid crystal 74 is positioned between the first electrode 70 and the second electrode 72.

The first electrode 70 includes a substantially transparent plastic substrate 80 coated with transparent conductive coating 82, and the second electrode 72 includes a substantially transparent substrate plate 80 coated with transparent conductive coating 82.

The surface of the first electrode 70, which is adjacent the liquid crystal 74, is treated with a first polymer layer 86 such that the first polymer layer 86 gives a preferential alignment to the adjacent liquid crystal 74. The surface of the second electrode 72, which is adjacent the liquid crystal 74, is treated with a second polymer layer 88 such that the second polymer layer 88 gives a preferential alignment to the adjacent liquid crystal.

Preferential alignment means that the liquid crystal molecules that are adjacent the polymer layers 86, 88 tend to orient with their long axes parallel to the direction to which the polymer layers 86, 88 are rubbed or brushed. The brushed direction of the first polymer layer 86 is substantially perpendicular to the brushed direction of the second polymer layer 88.

The preferential direction of the treated first polymer layer 86 should be substantially parallel to the direction of polarization of the first polarizing layer 76, and the preferential direction of the treated second polymer layer 88 should be substantially parallel to the direction of the second polarizing layer 78.

The liquid crystals 74 adjacent the first and second polymer layers 86, 88 are pre-tilted from the planes of the first and second polymer layers 86, 88. That is, in FIG. 9, the rod-like liquid crystals 74 make an angle with the first and second polymer layers 86, 88.

This pre-tilting of the liquid crystals adjacent the treated polymer layers facilitates the variable control of the alignment of the liquid crystals 74, and thus the variable control of the opacity of the light transmission control cell 66. A zero or small angle pre-tilt of liquid crystals adjacent to the places of polymer layers typically result in a device where a small change in externally applied stimulus such as an external electric field will cause a significant change in light transmission. A higher pre-tilt, in particular, a pre-tilt that is about 30° or more, will result in a light transmission control device whose light transmittance will changes smoothly when the external stimulus is changed.

Preferably, the pre-tilting angle is in a range from 0° to about forty-five degrees (45°). More preferably, the pre-tilting angle is about thirty degrees (30°).

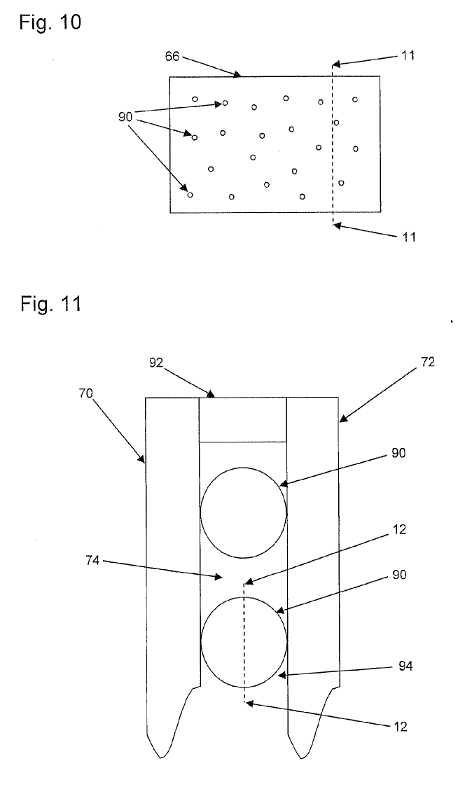

FIG. 10 shows that the light control transmission cell 66 further includes a plurality of spacers 90. The spacers 90 are coated with adhesive. The spacers 90 may be randomly or uniformly distributed within the light transmission control cell 66.

As shown in FIG. 11, the spacers 90 contact the first and second electrodes 70, 72 and maintain predetermined distance between the first and second electrodes 70, 72. The boundaries of the light transmission control cell 66 is sealed by adhesive 92.

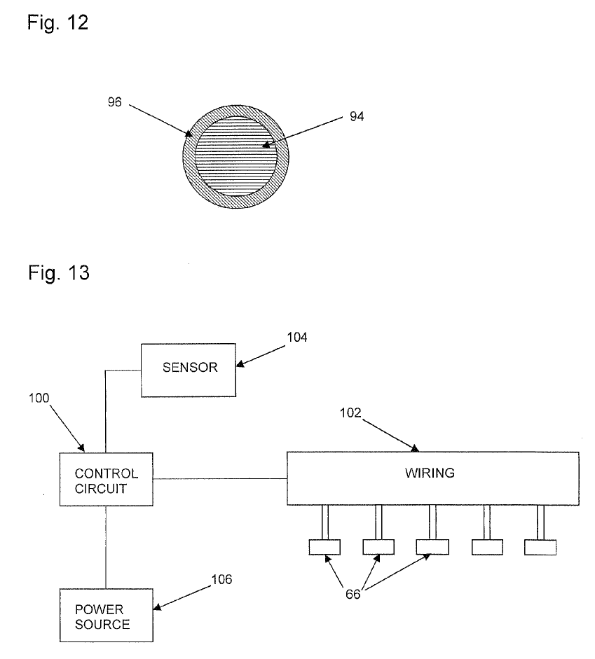

As shown in FIG. 12, the cross-section of the spacer 90 includes a sphere 94, and the sphere 94 is coated with an adhesive layer 96. The diameter of the sphere 94 should be in a range from about five (5) to about thirty (30) microns, and the thickness of the adhesive layer 96 is less than about five (5) microns. The spacer 90 having the adhesive layer 96 effectively maintains the distance between the first and second electrodes 70, 72, and protects the liquid crystal 74 against external force, so that the cell 66, and thus the film 50 may be curved, bent or flexed. More particularly, since the first and second electrodes 70, 72 of the light transmission control cell 66 are supported at multiple points, at which the randomly distributed spacers 94 are positioned, even though the cell 66 as a whole is bent, the distance between the first and second electrodes 70, 72, and hence the thickness of the cell 66 is kept constant throughout the cell 66, thereby protecting the cell 66 and the liquid crystal 74 inside.

Referring back to FIG. 9, the first flexible sheet 62 is coated with transparent electrically conductive coating 98. Preferably, the transparent conductive coating 98 is made of Indium Tin Oxide. The transparent conductive coating 98 forms an electrical wiring 102 (refer to FIG. 13) to each light transmission control cell 66.

FIG. 13 schematically shows how the light transmission control cells 66 are controlled. The adjustably opaque film 50 further includes a control circuit 100 that controls each of the light transmission control cells 66 individually with the electrical wiring 102. The control circuit 100 may also control the light transmission control cells 66 collectively in part or in whole depending on the requirements on the film 50 such as blocking most of the incident light, partial or gradual tinting of the window, or displaying specific images on the window.

The adjustably opaque film 50 may further include a light sensor 104 that measures the intensity of the incident light. The control circuit 100 controls the light transmission, or the opacity of the light transmission control cells 66, and thus of the light transmission control layer 56, based on data provided by the light sensor 104. On the other hand, the control of the light transmission control cells 66 may be overridden manually.

The adjustably opaque window further includes a power source 106 for supplying power to operate the light transmission control layer 56. In one application, the film 50 may be a vehicle window, and the power source 106 may be an array of photovoltaic cells (not shown) installed on a vehicle such as the upper portion of the windshield glass to harness and collect the sunlight, or may be simply the battery used in the vehicle.

In other applications, the adjustably opaque film 50 is an architectural window, a glass door, a partition, a mirror, a sun roof, a moon roof, or anywhere windows are used.

Referring back to FIG. 9, the adjustably opaque film 50 further includes an ultra violet light blocking layer 108 that is positioned between the first confining film 52 and the light transmission control layer 56.

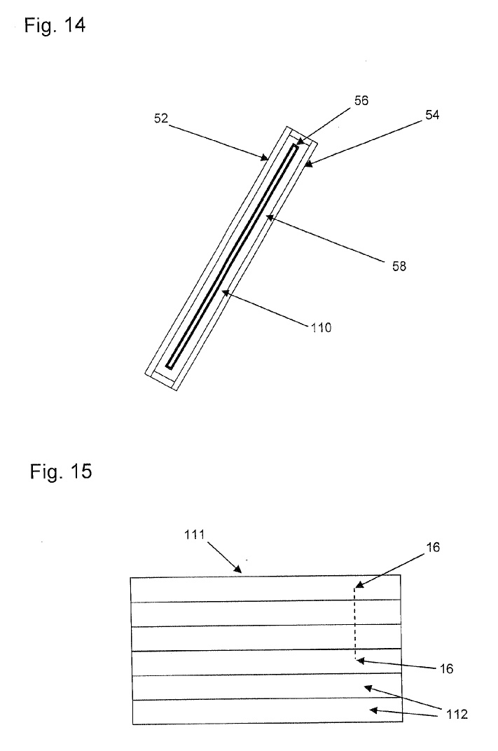

FIG. 14 shows another embodiment of the shock absorbing layer 58. The shock absorbing layer 58 includes gel 110 filled in the cavity 60, and the light transmission control layer 56 is supported in the gel 110.

The light transmission control cells and their arrangement are such that the said window seem seamless to human eyes. Also, the spacers within the light transmission control cells are microscopic in size and are not visible to human eye.

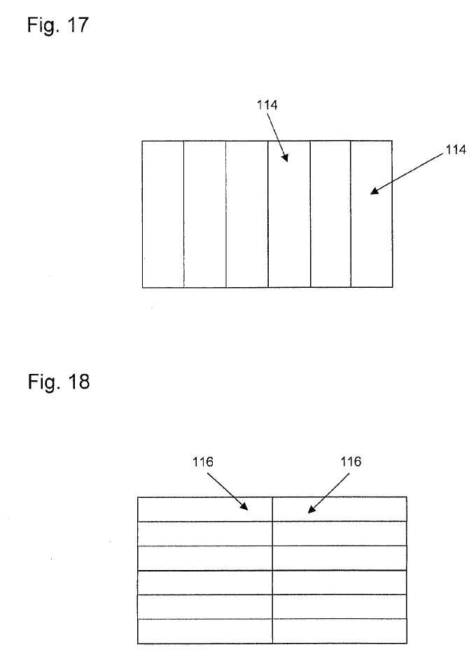

FIGS. 15-18 show another embodiment of the invention. In this embodiment, the cells are arranged so that part of the periphery of each cell is positioned at the periphery of the window. The wiring for each cell is positioned at the periphery of the window, and thus conductive coating on the shock absorbing layer is not required. FIG. 15 shows that six horizontal light transmission control cells 112 cover a whole adjustably opaque film 111. FIG. 17 shows that six vertical light transmission control cells 114 cover the whole window. FIG. 18 shows six pairs of horizontal light transmission control cells 116 cover the whole window.

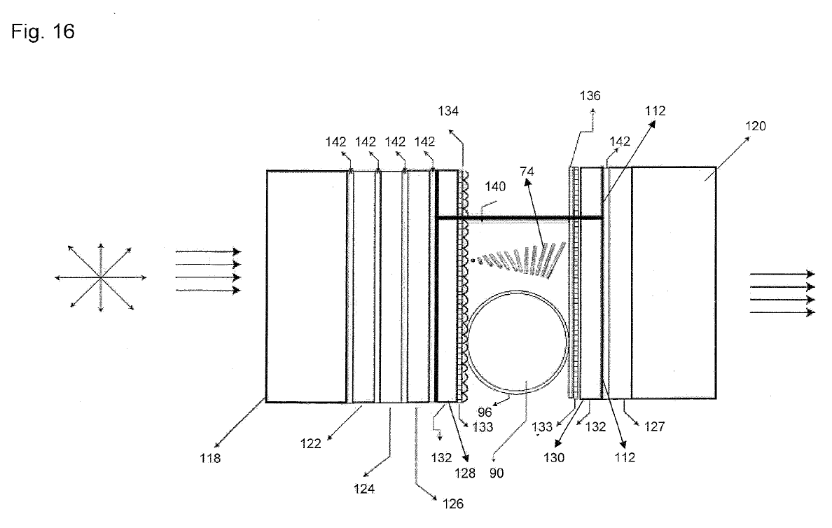

FIG. 16 shows the structure common to the light transmission cells 112, 114, 116. The adjustably opaque film 111 includes a first confining film 118 and an second confining film 120. Between the first confining film 118 and the second confining film 120, an ultra violet light blocking layer 122, a shock absorbing layer 124, a first polarizing layer 126, the light transmission control cell 112, and a second polarizing layer 127 are positioned in the order according to which they are listed. The light transmission control cell 112 includes a first electrode 128, and a second electrode 130 oppositely positioned with each other. Each of the first and second electrodes 128, 130 includes flexible plastic substrate 132, and a transparent conductive coating 133, which is made of, for example, Indium Tin Oxide, coated on the plastic substrate 132. Between the electrodes 128, 130, liquid crystal 74 is filled. A first polymer layer 134, which is brushed horizontally, is attached to the first electrode 128, and a second polymer layer 136, which is brushed vertically, is attached to the second electrode 130. The spacer 90 with the adhesive layer 96 is positioned between the electrodes 128, 130 and supports them. An adhesive 140 forms a seamless wall between the cells 112. Pressure sensitive adhesive 142 combines the first confining film 118, the ultra violet light blocking layer 122, the shock absorbing layer 124, the first polarizing layer 126, the light transmission control cell 112, and the second polarizing layer 127.

The panes, layers and cell of this embodiment have constructions similar to those explained with reference to FIG. 4-14.

Light incident on the window 111 is unpolarized. The light is first transmitted through the first confining film 118, and then through the ultra violet light blocking layer 122, in which the ultra violet light is prevented from further transmitting. Then the light is transmitted through the shock absorbing layer 124, which support and protect the light transmission control cells 112. Then the light transmission control cell 112 together with the polarizing layers 126, 127 control the opacity of the window 111, or transmission ratio of the incident light. Then the light, which is allowed to be transmitted further, is transmitted inside the window through the second confining film 120.

With the above construction, a stable and robust light transmission layer is achieved using liquid crystals. The liquid crystal cells constructing the light transmission layer are protected from external force by the shock absorbing layer, and also protected from adverse energy such as ultraviolet light or high temperature. When the adjustably opaque window is used in an automotive application, the window may be generally clear, when no electricity is applied, that is, the dormant state, such as when a vehicle is parked. When a driver gets in the vehicle, the control circuit senses the ambient lighting condition and adjusts the opacity of the window, or the driver may manually adjust the opacity for privacy purpose, etc. Alternately, the vehicle window may be totally dark and allow no light to enter when no electricity is applied, that is, the dormant state, by reverse arranging of the polarizing layers.

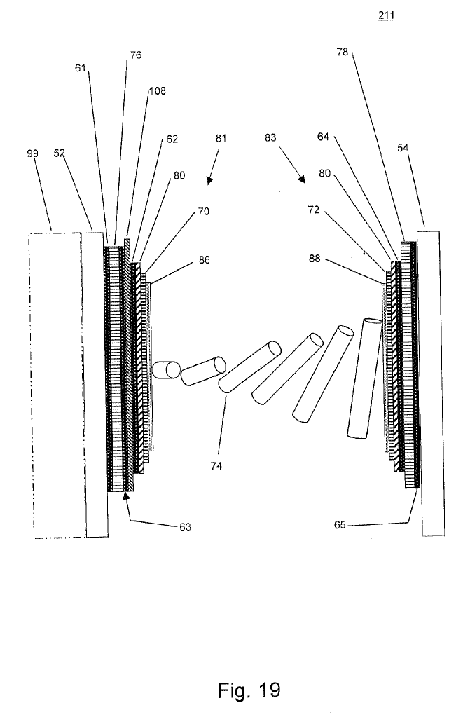

In another embodiment of the present invention as shown in FIG. 19, an adjustably opaque film 211, which is applied on a window panel 99 includes:

(1) A light transmission control layer 74;

(2) First and second electrodes 81, 83, enveloping the light transmission control layer 74, including a transparent electrically conductive coating 70, 72, a transparent plastic substrate 80, and a brushed polymer layer 86, 88;

(3) first and second inner shock absorbing layers 62, 64 enveloping light transmission control layer 74 and the electrodes 81, 83;

(4) first and second polarizing layers 76, 78 enveloping the light transmission control layer 74, the electrodes 81, 83, and the inner shock absorbing layers 62, 64;

(5) first and second outer shock absorbing layers 61, 65, having inner and outer surfaces, enveloping the light transmission control layer 74, the electrodes 81, 83, the inner shock absorbing layers 62, 64, and the polarizing layers 76, 78;

(6) a first substantially flexible and transparent confining film 52 disposed on the outer surface of the first outer shock absorbing layer 61; and

(7) a second substantially flexible and transparent confining film 54 disposed on the outer surface of the second outer shock absorbing layer 65.

The adjustably opaque film 211 may further include an ultraviolet light blocking layer 108 and a shock absorbing layer 63 that are positioned between the second confining film 52 and the light transmission control layer 74.

The interval between the first and second confining films 52, 54 is from about one (1) millimeter to about two (2) millimeters. This reduction in thickness of the opaque window is drastic compared to the prior art considering that it has a plurality of shock absorbing layers and other structure, which is not definitely obvious to the LCD industry. The adjustably opaque film according to the present invention may be embodied or used as a independent component that is applicable to a regular surface or a window pane.

Also, the substantially flexible confining film may include glass, preferably a thin and resilient glass.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An adjustably opaque film for applying over substantially smooth surface comprising:
a) a first substantially flexible and transparent confining film having an inner surface and an outer surface;
b) a second substantially flexible and transparent confining film having an inner surface and an outer surface, wherein the inner surfaces of the first and second confining films form a confined space layer; and
c) one or more light transmission control layer for controlling the intensity and frequency range of the transmitting light.

2. The adjustably opaque film of claim 1, wherein one of the first and second confining films is adapted to be attached to the substantially smooth surface.

3. The adjustably opaque film of claim 2, wherein the adjustably opaque film is adapted to be applied on a surface of the substantially smooth surfaces including car windows and building windows.

4. The adjustably opaque film of claim 1, wherein the adjustably opaque film is substantially flexible.

5. The adjustably opaque film of claim 1, wherein the interval between the first and second confining films varies substantially to fit a predetermined design requirements, wherein the interval is from about one (1) millimeter to about two (2) millimeters.

6. The adjustably opaque film of claim 1, wherein the light transmission control layer comprises a plurality of light transmission control cells, wherein the light transmission control cells are arranged to form a lattice.

7. The adjustably opaque film of claim 6, wherein the opacity of the light transmission control cells is variably adjustable, wherein the opacity of each of the light transmission control cells is adjusted by changing amplitude of electric field applied on the light transmission control cell.

8. The adjustably opaque film of claim 7, wherein each of the light transmission control cells comprises a first electrode, a second electrode, and an electro-optic material in between the first and second electrodes.

9. The adjustably opaque film of claim 8, wherein the electro-optic material comprises liquid crystal, or nonlinear optical material.

10. The adjustably opaque film of claim 9, wherein the liquid crystal comprises dichroic dye doped liquid crystals.

11. The adjustably opaque film of claim 9, wherein the liquid crystal comprises nematic liquid crystals with chiral dopants.

12. The adjustably opaque film of claim 9, wherein the liquid crystal comprises nematic liquid crystals without chiral dopants.

13. The adjustably opaque film of claim 9, wherein the liquid crystal comprises chiral nematic liquid crystals.

14. The adjustably opaque film of claim 9, wherein the liquid crystal comprises polymeric liquid crystals.

15. The adjustably opaque film of claim 9, wherein the liquid crystal comprises ferroelectric liquid crystals.

16. The adjustably opaque film of claim 9, wherein the liquid crystal is doped with dichroic light absorbing dye.

17. The adjustably opaque film of claim 9, wherein the liquid crystal is doped with pleochoric light absorbing dye.

18. The adjustably opaque film of claim 7, wherein the light transmission of the light transmission control cells is controllable manually.

19. The adjustably opaque film of claim 7, further comprising an array of photovoltaic cells, wherein the array provides electricity for operation of the light transmission control layer.

20. The adjustably opaque film of claim 19, wherein the adjustably opaque window is a vehicle window, and wherein the array is installed in a vehicle.

21. The adjustably opaque film of claim 1, further comprising:
a) two or more polarizing layers, wherein at least one polarizing layer is disposed each of the sides of the light transmission control layer; and
b) a plurality of shock absorbing layers interposed between any two of the confining films, light transmission control layers, and polarizing layers,
wherein the shock absorbing layers are adapted to support the layers mechanically and to hold the layers together, wherein the adjustably opaque film controls the light transmission by controlling the active optical property of the light transmission control layer.

22. The adjustably opaque film of claim 21, wherein the shock absorbing layer comprises a flexible sheet.

23. The adjustably opaque film of claim 22, wherein the shock absorbing layer is made of flexible plastic.

24. The adjustably opaque film of claim 22, wherein the thickness of the shock absorbing layer is in a range from about 0.1 to about 0.2 mm.

25. The adjustably opaque film of claim 22, wherein the shock absorbing layer is attached to the light transmission layer, polarizing layer, and confining film by glass lamination processes.

26. The adjustably opaque film of claim 22, wherein the shock absorbing layer is attached to the light transmission layer, polarizing layer, and confining film using pressure sensitive adhesive.

27. The adjustably opaque film of claim 22, wherein a first polarizing layer that is positioned between the first confining film and the light transmission control layer, and a second polarizing layer that is positioned between the first flexible sheet and the second confining film, wherein the direction of polarization of the first polarizing layer is substantially perpendicular to the direction of polarization of the second polarizing layer.

28. The adjustably opaque film of claim 27, wherein the first polarizing layer is integrated with the first confining film, and the second polarizing layer is integrated with the second confining film.

29. The adjustably opaque film of claim 27, wherein the first polarizing layer is absorptive.

30. The adjustably opaque film of claim 27, wherein the first polarizing layer is birefringence based.

31. The adjustably opaque film of claim 27, wherein the light transmission cell further comprises a first electrode that is substantially adjacent the first polarizing layer, and a second electrode that is substantially adjacent the second polarizing layer, wherein the liquid crystal is positioned between the first electrode and the second electrode.

32. The adjustably opaque film of claim 31, wherein the first electrode comprises a substantially transparent plastic substrate coated with transparent conductive coating, and wherein the second electrode comprises a substantially transparent plastic substrate coated with transparent conductive coating.

33. The adjustably opaque film of claim 31, wherein the surface of the first electrode, which is adjacent the liquid crystal, is treated with a first polymer layer such that the first polymer layer gives a preferential alignment to the adjacent liquid crystal, and the surface of the second electrode, which is adjacent the liquid crystal, is treated with a second polymer layer such that the second polymer layer gives a preferential alignment to the adjacent liquid crystal.

34. The adjustably opaque film of claim 33, wherein the liquid crystals adjacent the first and second polymer layers are pre-tilted from the planes of the first and second polymer layers, wherein the preferential direction of the treated first polymer layer is substantially parallel to the direction of polarization of the first polarizing layer, and the preferential direction of the treated second polymer layer is substantially parallel to the direction of the second polarizing layer.

35. The adjustably opaque film of claim 34, wherein the pre-tilting angle is in a range from 0° to about forty five (45) degrees.

36. The adjustably opaque film of claim 35, wherein the pre-tilting angle is about thirty (30) degrees.

37. The adjustably opaque film of claim 31, wherein the light control transmission cell further comprises a plurality of spacers, wherein the spacers maintain predetermined distance between the first and second electrodes.

38. The adjustably opaque film of claim 37, wherein all of the spacers are coated with adhesive.

39. The adjustably opaque film of claim 37, wherein part of the spacers are coated with adhesive.

40. The adjustably opaque film of claim 37, wherein the spacers are randomly distributed within the light transmission control cell.

41. The adjustably opaque film of claim 37, wherein each of the spacers comprises a sphere, and the sphere contacts the first and second electrodes.

42. The adjustably opaque film of claim 41, wherein the sphere is coated with an adhesive layer, wherein the diameter of the sphere is in a range from about five (5) to about thirty (30) microns, and wherein the thickness of the adhesive layer is less than about five (5) microns.

43. The adjustably opaque film of claim 22, wherein the first flexible sheet is coated with transparent electrically conductive coating.

44. The adjustably opaque film of claim 43, wherein the transparent conductive coating is made of Indium Tin Oxide.

45. The adjustably opaque film of claim 43, wherein the transparent conductive coating forms an electrical wiring to each light transmission control cell.

46. The adjustably opaque film of claim 45, further comprising a control circuit that controls each of the light transmission control cells individually with the electrical wiring.

47. The adjustably opaque film of claim 45, further comprising a control circuit that controls the light transmission control cells collectively in part with the electrical wiring.

48. The adjustably opaque film of claim 45, further comprising a control circuit that controls the light transmission control cells in whole with the electrical wiring.

49. The adjustably opaque film of claim 22, further comprising a light sensor that measures the intensity of the incident light, wherein the control circuit controls the light transmission of the light transmission control cells based on data provided by the light sensor.

50. The adjustably opaque film of claim 22, wherein the adjustably opaque window is an architectural window, a glass door, or a partition.

51. The adjustably opaque film of claim 22, further comprising an ultra violet light blocking layer that is positioned between the first confining film and the light transmission control layer.

52. The adjustably opaque film of claim 22, wherein the shock absorbing layer further comprises a second flexible sheet, wherein the second flexible sheet is attached to the light transmission control layer opposite to the first flexible sheet.

53. The adjustably opaque film of claim 21, wherein the shock absorbing layer comprises gel that fill the cavity, and the light transmission control layer is supported in the gel.

54. The adjustably opaque film of claim 21, wherein attachment among the first confining film, the second confining film, the light transmission control layer, and the shock absorbing layer is done with pressure sensitive adhesive.

55. An adjustably opaque film comprising:
a) a light transmission control layer;
b) first and second electrodes, enveloping the light transmission control layer, comprising a transparent electrically conductive coating, a transparent plastic substrate, and a brushed polymer layer;
c) first and second inner shock absorbing layers enveloping light transmission control layer and the electrodes;
d) first and second polarizing layers enveloping the light transmission control layer, the electrodes, and the inner shock absorbing layers;
e) first and second outer shock absorbing layers, having inner and outer surfaces, enveloping the light transmission control layer, the electrodes, the inner shock absorbing layers, and the polarizing layers;
f) a first substantially flexible and transparent confining film disposed on the outer surface of the first outer shock absorbing layer; and
g) a second substantially flexible and transparent confining film disposed on the outer surface of the second outer shock absorbing layer.

56. The adjustably opaque film of claim 55, further comprising an ultraviolet light blocking layer and a shock absorbing layer that are positioned between the second confining film and the light transmission control layer.

57. The adjustably opaque film of claim 55, wherein the interval between the first and second confining films varies substantially to fit a predetermined design requirements, wherein the interval is from about one (1) millimeter to about two (2) millimeters.
